(19) United States
(12) Patent Application Publication
(10) Pub. No.: US 2012/0189906 A1
(43) Pub. Date: Jul. 26, 2012

(54) SEALED BATTERY CASING AND SEALED BATTERY

(75) Inventors: Atsushi Nakajima, Chita-gun (JP); Atsushi Fukaya, Obu-city (JP); Teruhiko Kameoka, Okazaki-city (JP); Manabu Yamada, Okazaki-city (JP)

(73) Assignee: DENSO CORPORATION, Kariya-city (JP)

(21) Appl. No.: 13/353,416

(22) Filed: Jan. 19, 2012

(30) Foreign Application Priority Data
Jan. 21, 2011 (JP) 2011-11186

(51) Int. Cl. H01M 2/04

(52) U.S. Cl. 429/175

(57) ABSTRACT

A sealed battery casing includes a body part in which a power generation element is disposed and a sealing part that seals the body part by thermal fusion bonding. The body part includes one or more body members. The sealing part includes polyarylene sulfide-based resin having a residual ion concentration of 110 ppm or less on mass basis.

### CROSS REFERENCE TO RELATED APPLICATIONS

The present application is based on and claims priority to Japanese Patent Application No. 2011-11186 filed on Jan. 21, 2011, the disclosure of which is incorporated herein by reference.

### TECHNICAL FIELD

The present invention relates to a sealed battery casing and a sealed battery including a sealed battery casing.

### BACKGROUND

A secondary battery, such as a lithium battery, having a large capacity, a high output power, and a high energy density has attracted attention as a power source for driving a vehicle and a portable device.

A lithium battery includes a power generation element closed in a battery casing with a non-aqueous electrolyte. The power generation element includes a cathode and an anode that oppose each other through a separator. In each of the cathode and the anode, a mixed material layer mainly including electrode active material, which can accept lithium ions, is formed on a surface of a power collection member, such as a metal film.

Ingress of moisture into the battery casing of the lithium battery causes a decrease in battery performance. Specifically, when moisture exists in the battery casing, the moisture reacts with the non-aqueous electrolyte and generates fluoric acid. The generated fluoric acid corrodes components of the battery, such as the power generation element and the electrodes, and thereby deteriorating the battery performance, such as, a battery capacity and a battery life.

Thus, it is required to seal the battery casing of the lithium battery so that moisture does not enter the battery casing.

For example, JP-A-2002-245985 (corresponding to US 2003/0054241 A1, referred to as a patent document No. 1) discloses a battery casing that closes a power generation element. The battery casing includes a laminated film in which a barrier layer made of aluminum is put between polyolefin layers. By thermal fusion boding of the polyolefin layers, the battery casing can secure a sealing property. The thermal fusion bonding is a simple technique and can fuse the polyolefin layers with certainty.

In the battery casing, the laminated film also holds a battery lead, which protrudes from the power generation element, between the layers. Between the barrier layer made of aluminum and the battery lead, a heat-resistant base film made of, for example, polyphenylene sulfide is disposed so as to secure insulation between the barrier layer and the battery lead. When the polyolefin layer is heated and fused, the heat-resistance base film does not deform. Thus, the barrier layer does not come in contact with the battery lead.

If a battery is used in a large capacity and a high output power, a temperature of the battery increases. In addition, if the battery is subjected to a high temperature because of some reasons, the temperature of the battery increases. When the temperature of the battery increases, polyolefin softens and highly deforms. When the deformation of polyolefin is large, a creep failure may occur at a deformed portion. Accordingly, moisture may enter the battery casing from a failure portion and the battery performance may be deteriorated, or the electrolyte may leak from the battery casing.

### SUMMARY

In view of the foregoing problems, it is an object of the present invention to provide a sealed battery casing that can hermetically-close a power generation element therein for a long time. Another object of the present invention is to provide a sealed battery including a sealed battery casing.

A sealed battery casing according to a first aspect of the present invention includes a body part in which a power generation element is disposed and a sealing part that seals the body part by thermal fusion bonding. The body part includes one or more body members. The sealing part includes polyarylene sulfide-based resin having a residual ion concentration of 110 ppm or less on mass basis. The sealed battery casing can hermetically-close, the power generation element therein for a long time.

A sealed battery according a second aspect of the present invention includes a power generation element and a sealed battery casing. The sealed battery casing includes a body part in which the power generation element is disposed and a sealing part that seals the body part by thermal fusion bonding. The body part includes one or more body members. The sealing part includes polyarylene sulfide-based resin having a residual sodium ion concentration of 80 ppm or less on mass basis. In the sealed battery, the sealed battery casing can hermetically-close the power generation element therein for a long time.

### BRIEF DESCRIPTION OF THE DRAWINGS

Additional objects and advantages of the present invention will be more readily apparent from the following detailed description when taken together with the accompanying drawings. In the drawings:

FIG. 1 is a diagram showing a test battery according to an example;

FIG. 2A is a cross-sectional view showing a portion of a sealed battery casing in which a battery lead is disposed, FIG. 2B is a cross-sectional view showing another portion of the sealed battery casing, and FIG. 2C is a cross-sectional view showing a sealing part according to an example;

FIG. 3 is a graph showing a relationship between a residual ion concentration and a creep failure time; and

FIG. 4 is a diagram showing compositions, the number of layers, thicknesses, residual ion concentrations, copolymer ratios, moisture vapor transmission rates, deflection temperatures under load, and creep failure times of sealing parts included in test batteries according to first to seventh examples.

### DETAILED DESCRIPTION

Before describing embodiments of the present invention, knowledge obtained from a study by the inventors will be described below.

According to the study by the inventors, when polyarylene sulfide-based resin (PAS-based resin) is used as material of a sealing part, which is subjected to thermal fusion bonding, a power generation element can be hermetically-closed in a battery casing stably. In normal use situation, the polyarylene sulfide-based resin does to reach a temperature at which a creep failure occurs.

In cases where the polyarylene sulfide-based resin is used at a portion that is in contact with metal directly, a sufficient stability may not be achieved under a hard environment. For example, corrosion may occur at a joint portion of the polyarylene sulfide-based resin and a metal member. The corrosion occurs because of residual ions in the polyarylene sulfide-based resin and the corrosion can be restricted by reducing a residual ion concentration.

As a method of manufacturing the polyarylene sulfide-based resin, a polymerizing method with sodium salt can be used. Although residual sodium ions are removed partially, it requires a high cost to remove the residual sodium ions completely. In general, the polyarylene sulfide-based resin includes residual ions, such as sodium ions, of hundreds ppm or more. Even when the polyarylene sulfide-based resin is used for a secondary battery, a concentration of residual ions, such as sodium ions, is not viewed with suspicion and the residual ions are not removed in particular.

A sealed battery casing and a sealed battery according to embodiments of the present disclosure will be described below. The sealed battery casing according to the present embodiment can be applied to any battery. For example, the sealed battery casing may be applied to a non-aqueous secondary battery, such as a lithium secondary battery, in which ingress of moisture into a power generation element causes a big issue. The sealed battery casing may also be applied to a battery in which ingress of moisture does not cause an issue because it is preferable that a sealing property of a battery casing is high. In the following description, the sealed battery casing is applied to a lithium secondary battery, as an example.

(Sealed Battery Casing)

The sealed battery casing according to the present embodiment includes a body part and a sealing part. In the body part, a power generation element of a battery is disposed. The body part may include two or more body members and may hermetically-close the power generation element therein by combining the body members. The body part may also include one body member that closes the power generation element by bending or winding. The body part may also have a depression, for example, formed by drawing, and the power generation element may be disposed in the depression. The body part may also be casings of a button battery (respectively serving as a cathode and an anode). The body part may also function as an electrode of a cylindrical battery or an angular battery.

The sealing part seals a clearance between joint portions of the body part when the power generation element is closed in the body part. In addition, the sealing part joins the joint portions of the body part. Shapes of the joint portions sealed by the sealing part are not limited. It is preferable that the joint portions have a large area and a thickness of the sealing part is small.

The body part may be made of metal (such as, copper, aluminum, stainless), resin, or a laminated film in which a metal layer and a resin layer is stacked. The material of the body part may be selected based on moisture transmission rate, hardness, mass, and chemical stability required for the sealed battery casing.

In the clearance of the body part, a battery lead, which transfers power between an inside and an outside of the battery, may be disposed. The battery lead may be made of a conductive material, such as metal. In the clearance of the body part sealed by the sealing part, the battery lead may be directly joined to the sealing part. When the sealing part according to the present embodiment is employed and the battery lead is directly joined to the sealing part, a progress of a creep failure can be restricted. Because not covered with polyolefin and the like, a creep failure does not proceed at a covered portion. In cases where portions of the body part and the battery lead to which the sealing part is attached by thermal fusion bonding are not subjected to a roughening treatment, the sealed battery casing can have a high sealing property, and a joint strength can be increased. Surfaces of the body part and the battery lead may be subjected to an anticorrosion treatment. The surfaces of the body part and the battery lead may also be subjected to a plating processing (for example, nickel plating to copper).

The sealing part seals the clearance of the body part. The shape of the sealing part is not limited. As described above, it is preferable that the sealing part has a plate shape in which a portion that joins the joint portions of the body part has a large area and the thickness is small. When the sealing part having the film shape is treated with thermal fusion bonding in a state where the sealing part is held between joint portions of the body part, the joint portions of the body part can be bonded at a large area. Thus, the joint portions of the body part can be tightly bonded and ingress of moisture into the sealed battery casing can be restricted. When the sealing part has a film shape, a stretching ratio may be set to 3 or less. The stretching ratio may also be set to 2.5 or less, and the stretching ratio may also be set to 2 or less. Because a mechanical strength of a film increases by stretching, a high stretching ratio is employed in general. However, when the film is stretched, contraction at fusion becomes large, and the film is cooled and solidified in a state where the film includes a stress of contraction at the thermal fusion bonding. Thus, it is preferable that the stretching ratio is low.

The sealing part may thinly cover a surface of body part. For example, the sealing part may be films that hold a metal film therebetween. When the sealing part is the films holding the metal film therebetween, the thermal fusion bonding can be performed in a state where the power generation element is disposed in the body part. In the present case, a portion of the sealing part can work as the joint portions of the body part. In an example, the body part may be a metal film, the sealing part attached on an inside of the body part may be a film made of the PAS-based resin and the sealing part attached on an outside of the body part may be a film made of polyolefin and the like, and the films may be laminated. In another example, the body part may be a metal film, the sealing part attached on the inside of the body part may be a film made of polyolefin and the like, the sealing part attached on the outside of the body part may be made of a film made of the PAS-based resin, the film made of PAS-based resin may be folded at the joint portion and the thermal fusion bonding is performed at a portion of the film made of the PAS-based resin. In this case, a portion of the sealing part being in contact with the electrolyte stored in the body part and the portion of the sealing part treated with the thermal fusion bonding can be made of different materials. Thus, appropriate materials can be used.

The polyarylene sulfide (PAS)-based resin used as a material of the sealing part is a material that includes repeating units in which arylene and sulfide are bonded (—Ar—S—) as a primary component. Where, “the resin that includes the repeating units in which arylene and sulfide are bonded (—Ar—S—) as the primary component” includes the following cases. In one case, the repeating units, in which arylene and sulfide are bonded, and other component are included in the same molecule, and a ratio of the repeating units in which arylene and sulfide are bonded is 50% or more on mass basis (hereafter, referred to as modified PAS). In another case, a polymer (PAS) made of the repeating units, in which arylene and sulfide are bonded, and a polymer having other chemical structure are mixed, and a ratio of PAS is 50% or more on mass basis (hereafter, referred to as PAS polymer blend).

The repeating units in which arylene and sulfide are bonded may have a bifunctional chemical structure as indicated by (—Ar—S—), and may also have a trifunctional chemical structure. When the repeating units include the trifunctional chemical structure, a network structure can be introduced in the chemical structure. For example, the trifunctional chemical structure includes a case in which one hydrogen is further removed from arylene, and two of trivalent substituent are bonded with sulfide. A content rate of the repeating units having the trifunctional chemical structure may be 1 mol % or less.

Arylene (Ar) may include, for example, phenylene (—C₆H₄—), naphtylene (—C₁₀H₆—), anthrylene, phenanthrylene, pyrelyne, and coronylene. In particular, phenylene and naphtylene are preferable arylene. Phenylene includes p-phenylene, o-phenylene, and m-phenylene. In particular, p-phenylene and m-phenylene are preferable. Naphtylene includes 1,2-, 1,3-, 1,4-, 1,6-, 1,7-, 1,8-, 1,9-, 2,3-, 2,6-, and 2,7-naphtylene. Arylene (Ar) may include at least one of arylene groups represented by the following chemical formulas (1) to (11):

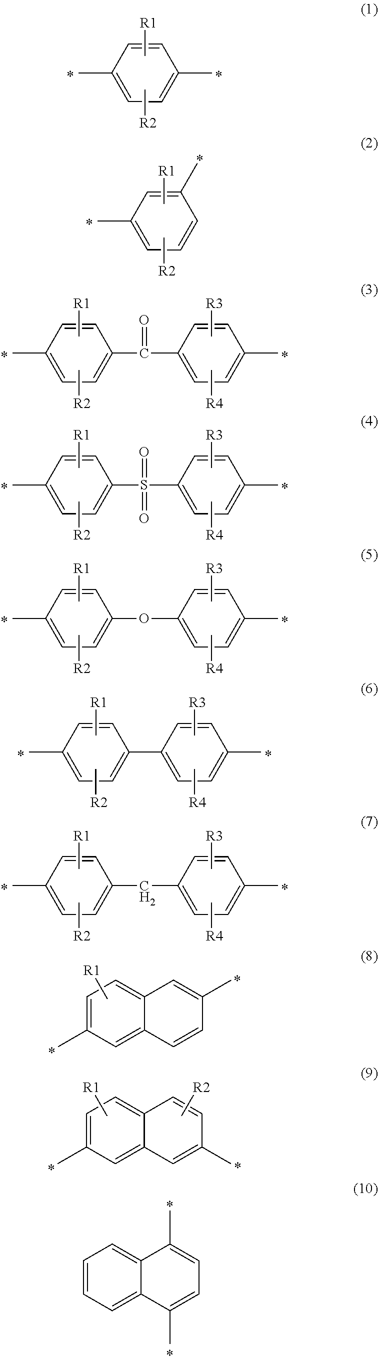

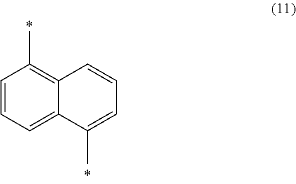

where R1 to R4 are selected from hydrogen, alkyl group, alkoxy group, and halogen group. R1 to R4 may be the same or different. Even in material represented by the same chemical formula, R1 to R4 may be different from each other. In chemical formulas (1) to (11), * represents other coupled atom.

Arylene represented by chemical formulas (1) to (11) (e.g., m-phenylene) may be included with a ratio of at least 5 mol % and at most 30 mol % on a basis of the number of repeating units (mol number). An upper limit of the content of arylene may be 25 mol % or 20 mol %. A lower limit of the content of arylene may be 10 mol % or 15 mol %. These values may be combined optionally. A remaining repeating units may be p-phenylenesulfide in which p-phenylene is included in Ar. As the modified PAS, compounds disclosed in JP-A-2007-98941 may be used.

The PAS polymer blend may include material in which acid modified polyolefin as the polymer having other chemical structure is blended to PAS. Polymer blending may be performed, for example, by mixing. A mixing ratio of PAS and the polymer having other chemical structure is set so that a creep failure does not proceed when the PAS polymer blend is subjected to an operating temperature of the sealed battery and a pressure in the sealing battery for a required time. The progression of a creep failure can be restricted by increasing the ratio of PAS. When the ratio of the polymer having other chemical structure is increased, a property, such as thermal fusion bonding property, of the polymer having other chemical structure can be exerted. For example, the polymer having other chemical structure may be mixed with a ratio of at least 1 mass % and at most 20 mass % on basis of mass of the whole PAS-based resin included in the sealing part. The polymer having other chemical structure may also be mixed within a ratio of at least 3 mass % and at most 15 mass %. The polymer having other chemical structure may also be mixed with a ratio of at least 5 mass % and at most 10 mass %.

For example, when acid modified polyolefin as the polymer having other chemical structure is blended with PAS to make PAS polymer blend, a detection temperature under load can be increased, and creep failure is less likely to occur. Acid modified polyolefin may include maleic anhydride modified ethylene copolymer. Maleic anhydride modified ethylene copolymer may be any material in a category which is generally called maleic anhydride ethylene copolymer. For example, maleic anhydride modified ethylene copolymer may include maleic anhydride graft modified ethylene copolymer, maleic anhydride-ethylene copolymer. As maleic anhydride modified ethylene copolymer, for example, “Melthene®-P” manufactured by Tosoh Corporation, “ADMER®” manufactured by Mitsui Chemicals, Inc., “BONDINE®” manufactured by Atofina Chemicals, inc. are available.

When maleic anhydride-alkyl acrylate-ethylene terpolymer is used as maleic anhydride modified ethylene copolymer, the sealing part can have high bonding property and high adhesion property. As maleic anhydride-alkyl acrylate-ethylene terpolymer, for example, “BONDINE®” manufactured by Atofina Chemicals, Inc. is available.

When maleic anhydride-alkyl acrylate-ethylene terpolymer is blended in the PAS polymer blend, maleic anhydride-alkyl acrylate-ethylene terpolymer may be included with a ratio of at least 1 mass % and at most 30 mass % on basis of mass of the whole PAS-based resin. When terpolymer is included in the PAS-based resin with the above-described ratio, the sealing part can have high bonding property, a high adhesion property, and a low moisture transmission rate.

The PAS-based resin may further include filler. The filler may include fibrous filler and inorganic filler. The fibrous filler may include a glass fiber, a whisker, an inorganic fiber, an organic fiber, and a mineral fiber.

The glass fiber may include, for example, glass fibers, such as chopped strand, a milled fiber, a roving, a silane fiber, an aluminosilicate glass fiber, a hollow glass fiber, and a non-hollow glass fiber, which have an average fiber diameter of at least 6 μm and at most 14 μm.

The inorganic fiber may include, for example, zirconia, alumina-silica, barium titanate, silicon carbide, alumina, silica, and blast furnace slag.

The mineral fiber may include, for example, asbestos, rock wool, wollastonite, and magnesium oxysulfate.

The organic fiber may include, for example, a wholly aromatic polyamide fiber, a phenol resin fiber, and a wholly aromatic polyester fiber.

The whisker may include, for example, a silicon nitride whisker, a basic magnesium sulfate whisker, a barium titanate whisker, a potassium titanate whisker, a silicon carbide whisker, a boron whisker, and a zinc oxide whisker.

The inorganic filler may be a plate-shaped or powder-shaped inorganic substance. For example, the inorganic filler may include calcium carbonate, lithium carbonate, magnesium carbonate, zinc carbonate, mica, silica, talc, clay, calcium sulfate, kaolin, wollastonite, zeolite, glass powder, alumina, silica, magnesium oxide, zirconia, ferrous oxide, tin oxide, magnesium silicate, calcium silicate, calcium phosphate, magnesium phosphate, graphite, carbon black, glass powder, glass balloons, glass flakes, and hydrotalcite.

Two or more of the above-described fillers may be combined. In necessary, a surface of the filler may be treated with a functional compound or a polymer including an isocyanate-based compound, a silane-based compound, or a titanate-based compound.

The fiber filler and the inorganic filler may be treated with a silane coupling agent or a titanate-based coupling agent. For example, surfaces of the fiber filler and the inorganic filler may be treated with amino-alkoxylsilane or epoxy-alkoxylsilane. After the surface of the fiber filler is treated with the above-described way, glass fibers may be bundled using one or both of epoxy resin and urethane resin.

Polyphenylene sulfide composition may include one or more of a crystal nucleating agent, such as talc, kaolin, silica, plasticizer, such as polyalkylene oxide oligomer-base compound, thioether-based compound, ester-base compound, and organic phosphorous compound, antioxidizing agent, heat stabilizer, lubricant, ultraviolet-ray protective agent, coloring agent, and foaming agent.

The sealing part may include an inner, portion and an outer portion disposed on a surface of the inner portion, the inner portion may be made of polyphenylene sulfide (PPS) and the outer portion may be made of the PAS-based resin other than PPS. The outer portion may be made of the PAS-based resin having a high thermal adhesion property. PPS has a low moisture transmission property and is cheaper than the PAS-based resin other than PPS. Thus, when the inside portion is made of PPS and the outer portion where a high adhesiveness is required is made of the PAS-based resin, properties, such as, moisture transmission property, can be improved.

For example, the sealing part may include a thin layer made of PPS and layers made of the PAS-based resin other than PPS, and the layers made of the PAS-based resin may hold the thin layer made of PPS therebetween in a thickness direction of the sealing part. In the above-described case, an outer portion has a lower softening point than an inner portion. Thus, by performing thermal fusion bonding at a temperature at which only the outer portion is soften, even when body members of the body part are made of metal, respectively function as the cathode and the anode, and should not be in contact with each other, the body members can be bonded through the sealing part with certainty.

A residual ion concentration of the PAS resin is 110 ppm or less. An upper limit of the residual ion concentration is 100 ppm, 90 ppm, 85 ppm, 80 ppm, 75 ppm, 70 ppm, 65 ppm, 60 ppm, or 50 ppm. By setting the residual ion concentration to be lower than the above-described value, durability of the joint portions can be increased. A lower limit of the residual ion concentration may be 10 ppm, 20 ppm, and 30 ppm. By setting the residual ion concentration to be higher than the above-described value, sufficient durability of the joint portions can be secured. The above-described values can be combined optionally.

As the residual ion concentration, it is not required to evaluate the whole ion concentration, and similar advantage can be obtained by controlling only a sodium ion concentration to be within the above described range. A method of reducing the residual ion concentration (residual sodium ion concentration) is not limited. For example, the residual ion concentration can be reduced by cleaning the PAS-based resin with solvent in which the residual ions are soluble. When the PAS resin has a large specific surface or when a cleaning temperature is high, the residual ion concentration can be reduced quickly. The ion concentration can be measured by a known method. A value that is obtained by detecting a metal element, for example, by atomic absorption spectrometry may be used as the ion concentration without detecting the ion concentration.

The PAS-based resin may have a deflection temperature under load (JIS K7191, A-method) of 80° C. or higher. A lower limit of the deflection temperature under load may also be 90° C. or 100° C. The deflection temperature under load is decreased by introducing repeating units other than the repeating units in which phenylene is employed as Ar.

The PAS-based resin may have a moisture vapor transmission rate (JIS K7129, B-method) of 15 mL/m²·24 h/atm or less at a temperature of 40° C. and a relative humidity of 95% in a film state with a thickness of 100 μm, where 1 atm is 101325 Pa. An upper limit of the moisture vapor transmission rate may also be 10 mL/m²·24 h/atm. The moisture vapor transmission rate is decreased by increasing the ratio of the repeating units in which phenylene is employed as Ar.

The sealed battery casing according to the present embodiment is sealed in a state where the power generation element is disposed therein. For example, an electrode body is formed by winding or stacking the cathode and the anode in a state where the separator is held between the cathode and the anode, and the electrode body is disposed in the body part. At the clearance of the body part, the sealing part is disposed. In the above-described state, the body part and the sealing part is applied with pressure while being heated at a temperature at which the sealing part is fused, and thereby the body part and the sealing part are bonded to each other. When the thermal fusion bonding is performed in a state where the battery lead is disposed on the sealing part, the battery lead can be fixed. A part of the clearance of the body part may remain open, without being subjected to the thermal fusion bonding, to form an inlet portion, and the electrolyte may be put in the boy part from the inlet portion. Then, the inlet portion may be closed, for example, by thermal fusion bonding. When the inlet portion is closed, the sealing part according to the present, embodiment may be used.

(Sealed Battery)

The sealed battery according to the present embodiment includes the above-described sealed battery casing and a power generation element. The power generation element is not limited and may have various structures depending on the kind of the sealed battery. For example, the sealed battery may be a battery including a non-aqueous electrolyte as an electrolyte, such as a lithium secondary battery.

The power generation element includes a cathode, an anode, and an electrolyte. The power generation element may include a separator that prevents a contact between the cathode and the anode. Each of the cathode and the anode includes active material with which battery reaction proceeds. A configuration of an electrode body is not limited. For example, the electrode body may have a winding structure or a stacking structure in which a plurality of electrodes are stacked or one electrode is folded.

The cathode and the anode are coupled with respective electrode terminals that introduce power generated by the battery reaction of the active materials to an outside of the battery casing. The cathode and the anode may be electrically coupled with the respective electrode terminals directly or indirectly through a battery lead. The electrode terminal and the battery lead may be provided by portions of the battery casing made of conductive material, such as metal. For example, the battery casing may include two or more members made of conductive material, a part of the members may work as an electrode terminal of the cathode, and other part of the members may work as an electrode terminal of the anode. The electrode terminal of the cathode and the electrode terminal of the anode are electrically isolated by the sealing part.

When portions of the body part are not used as the electrode terminals or the battery lead, a battery lead that couples the inside and the outside of the battery casing may be provided. The battery lead may be disposed at a portion sealed with the sealing part. When a battery lead made of metal is sealed with the sealing part, a sealing property at a joint portion can be secured for a long time.

### EXAMPLES

Test batteries according to first to seventh examples are formed. Each test battery is a lithium secondary battery in which a lithium nickel compound oxide represented by LiNiO₂ is used as cathode active material and graphite is used as anode active material.

A cathode of each test battery is formed as described below. Firstly, 87 parts by mass of LiNiO₂, 10 parts by mass of carbon black as conductive material, and 3 parts by mass of polyvinylidene fluoride (PVdF) as conclusion agent are mixed. Then, a proper amount of N-methyl-2-pyroridone is added and mixed to form a cathode composite. The cathode composite is applied to two surfaces of a cathode collector made of aluminum and having a thickness of 15 μm. The cathode collector is dried and pressed to form a cathode having a sheet shape. The cathode is cut into a cathode plate having a band shape. The cathode composite is scratched out from a portion of the cathode plate, and a battery lead of the cathode is bonded to the portion.

An anode of each test battery is formed as described below. Firstly, 95 parts by mass of graphite and 5 parts by mass of PVdF as conclusion agent are mixed. Then, a proper amount of N-methyl-2-pyroridone is added and mixed to form an anode composite. The anode composite is applied to two surfaces of an anode collector made of copper and having a thickness of 10 μm. The anode collector is dried and pressed to form an anode having a sheet shape. The anode is cut into an anode plate having a band shape. The anode composite is scratched out from a portion of the anode plate, and a battery lead of the anode is bonded to the portion.

The cathode plate and the anode plate, between which a separator is disposed, are wound into a flat shape to form a winding electrode body. An outermost portion of the electrode body is wound with the separator so as to secure insulation from surround.

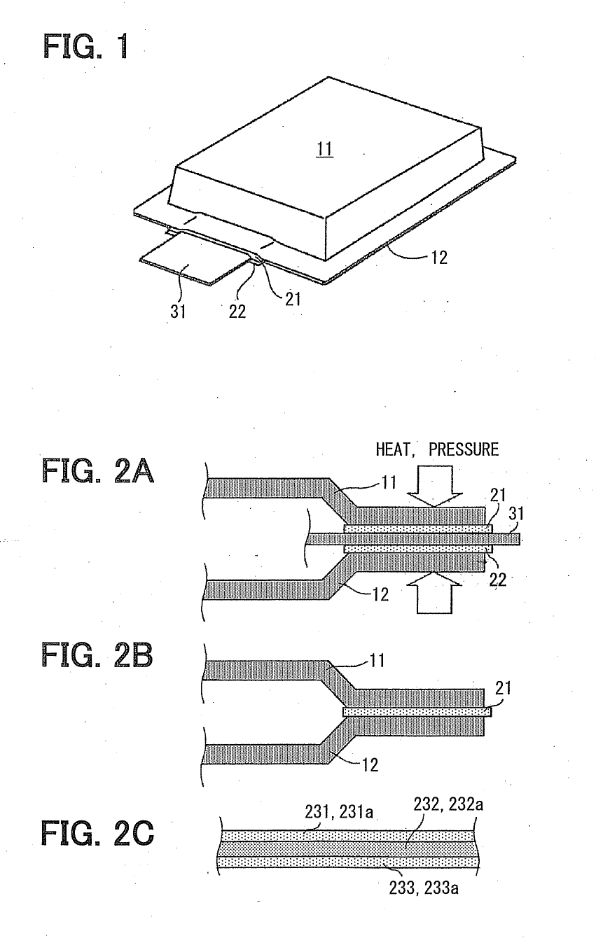

As shown in FIG. 1, the body part includes body members 11, 12. Each of the body members 11, 12 is made of an aluminum plate and having a depressed portion formed by shallow drawing. The electrode body is disposed in the depressed portion. Between the body members 11, 12, sealing parts 21, 22 are disposed. By heating and fusing the sealing part, the body members 11, 12 and the sealing parts 21, 22 are bonded.

As shown in FIG. 2A, at a portion where a battery lead 31 is disposed, the battery lead 31 is held between the sealing parts 21, 22 so as to secure insulation between the body members 11, 12 and a sealing property of the sealed battery. At a portion where the battery lead 31 is not disposed, as shown in FIG. 2B, the body members 11, 12 are sealed only with the sealing part 21.

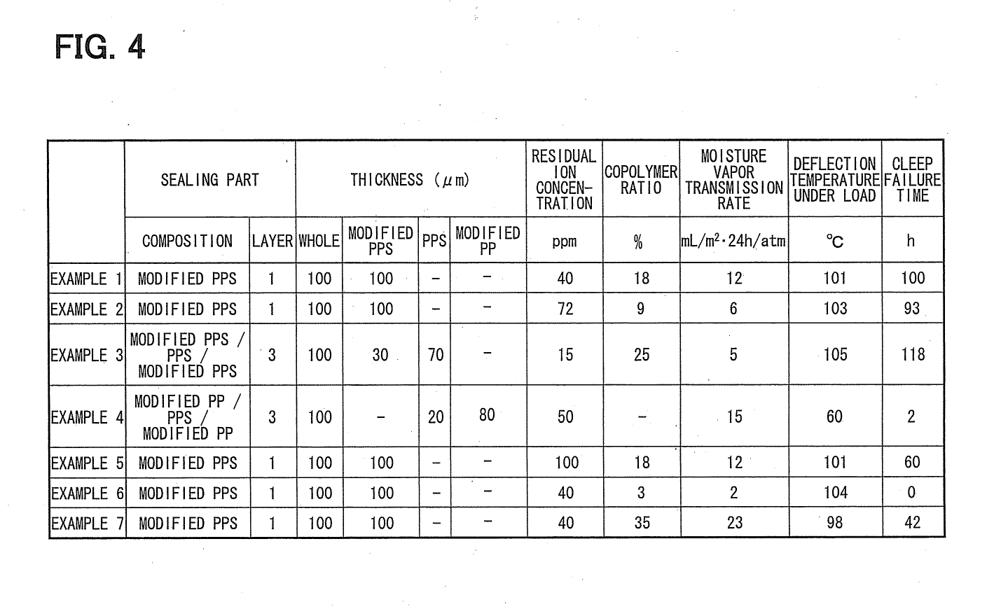

In a column of a sealing part in FIG. 4, a composition of the sealing part and the number of layers in each example are shown. In a description of the composition, divisions with “/” indicate that three layers are stacked in the described order. In the test battery according to the third example, as shown in FIG. 2C, the sealing part includes modified PPS films 231, 233 having a thickness of 15 μm and a PPS film 232 having a thickness of 70 μm, and the PPS film 232 is disposed between the modified PPS films 231, 233. In the test battery according to the fourth example, the sealing part includes modified PP films 231a, 233a having a thickness of 40 μm and a PPS film 232a having a thickness of 20 μm, and the PPS film 232a is deposed between the modified PP films 231a, 233a. The modified PPS is formed by copolymerizing unit structure of phenylene sulfide and other unit structure. As other unit structure, (—Ar—S—) in which Ar is chemical formula (2) and each of R1 and R2 is hydrogen is used. By copolymerizing other unit structure, an adhesiveness can be improved. Copolymer ratios shown in FIG. 4 are mass ratios. The modified PP is copolymer of propylene and maleic anhydride. Residual ion concentrations shown in FIG. 4 are sodium ion concentrations measured by atomic absorption method. The residual ion concentrations are controlled with a water cleaning time.

The deflection temperatures under load are measured according to the A-method of JIS K7191. The moisture vapor transmission rates, are measured according to the B-method of JIS K7129 with PERMATRAN-W3/31 manufactured by MOCON. Each test battery is conducted a breakdown test as described below. Each test battery is initially charged to a full charge state and is left at a temperature of 60° C. and a relative humidity of 95% for one month. Then, a hole is created in the battery casing so that an internal pressure becomes 0.5 MPa, and a time that elapses before a creep failure occurs at a joint portion is measured. A pressure in the battery casing is monitored with a pressure gauge AP-13S manufactured by Keyence Corporation, and it is determined that a creep failure occurs when the pressure becomes 0.05 MPa or less. The results are shown in FIG. 4. In the breakdown test, a relationship between durability and the kind of the PAS-based resin is evaluated. According to the results of the breakdown test, each test battery has a higher durability than a battery in which a sealing part is made of only polyolefin.

As shown in FIG. 4, when the sealing part includes PPS or modified PPS as the PAS-based resin, the creep failure time can be increased. In the sixth example, the creep failure time is 0 hour because a portion subjected to the thermal fusion bonding with the sealing part according to the sixth example has a low strength. Even when the sealing part according to the sixth example is used, a battery casing can be tightly joined by changing conditions of the thermal fusion bonding. In the sixth example, because the copolymer ratio is low, the moisture vapor transmission rate is restricted at a low value.

In the test battery according to the seventh example, in which the sealing part has the same degree of residual ion concentration with the test battery according to the first example, the creep failure time is less than a half of the creep failure time in the first example. This is because the sealing part used in the test battery according to the seventh example has a high moisture vapor transmission rate, a large amount of moisture is transmitted into the battery casing, the electrolyte decomposition proceeds, and fluoric acid is generated.

Because the test batteries according to the first to third examples respectively have residual ion concentrations of 40 ppm, 72 ppm, 15 ppm, which are relatively low, the creep failure times of the test batteries according to the first to third examples can be longer than the test battery according to the fifth example, which has a residual ion concentration of 100 ppm. This is because the amount of residual ions eluted from the sealing part is small, and the joint portion is less likely to be corroded. Even in the test battery according to the fifth example, the creep failure time can be long and the moisture vapor transmission rate can be low compared with the test battery according to the fourth example.

A relationship between the creep failure time and the residual ion concentration is studied with test batteries having different residual ion concentrations. The test batteries have configurations similar to the test battery according to the third example shown in FIG. 4 except the residual ion concentration.

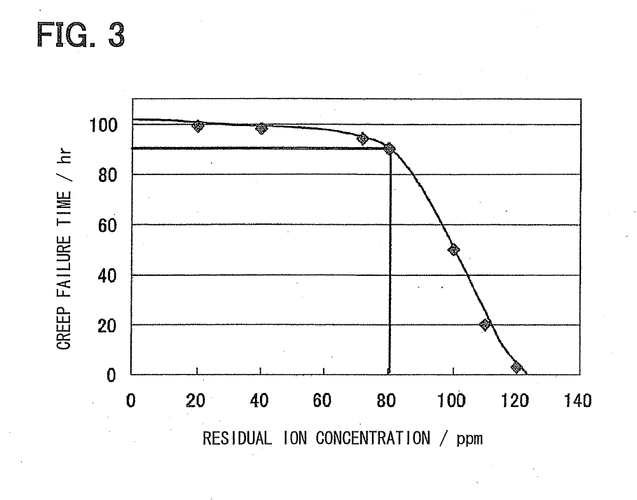

Each test battery is initially charged to a full charge state and is left at a temperature of 60° C. and a relative humidity of 95% for one month. Then, a hole is created in the battery casing so that an internal pressure becomes 0.5 MPa, and a time that elapses before a creep failure occurs at a joint portion is measured. The results are shown in FIG. 3.

As shown in FIG. 3, when the residual ion concentration is 110 ppm or less, a long creep failure time can be achieved. In particular, when the residual ion concentration is 100 ppm or less, a longer creep failure time can be achieved. In a range of 80 ppm or less, the creep failure time is substantially the same. Thus, it is presumed that influence of the residual ion concentration on the creep failure time is saturated with the residual ion concentration of 80 ppm or less.

What is claimed is:

1. A sealed battery casing comprising:
a body part in which a power generation element is disposed, the body part including one or more body members; and
a sealing part sealing the body part by thermal fusion bonding, the sealing part including polyarylene sulfide-based resin, the polyarylene sulfide-based resin having a residual ion concentration of 110 ppm or less on mass basis.

2. The sealed battery casing according to claim 1, wherein
the residual ion concentration is a residual sodium ion concentration.

3. The sealed battery casing according to claim 1, wherein
the polyarylene sulfide-based resin has a deflection temperature under load of 80° C. or higher.

4. The sealed battery casing according to claim 1, wherein
the polyarylene sulfide-based resin has a moisture vapor transmission rate of 15 mL/m²·24 h/atm or less at a temperature of 40° C. and a relative humidity of 95% in a film state with a thickness of 100 μm.

5. The sealed battery casing according to claim 1, wherein
the sealing part includes an inner portion and an outer portion disposed on a surface of the inner portion,
the inner portion is made of polyphenylene sulfide, and
the outer portion is made of the polyarylene sulfide-based resin that has a different composition from polyphenylene sulfide.

6. The sealed battery casing according to claim 1, wherein
the polyarylene sulfide-based resin is a polymer including repeating units of (—Ar—S—), and
the Ar includes at least one of arylene groups represented by chemical formulas (1) to (11) with a ratio of at least 5 mol % and at most 30 mol % of the repeating units: 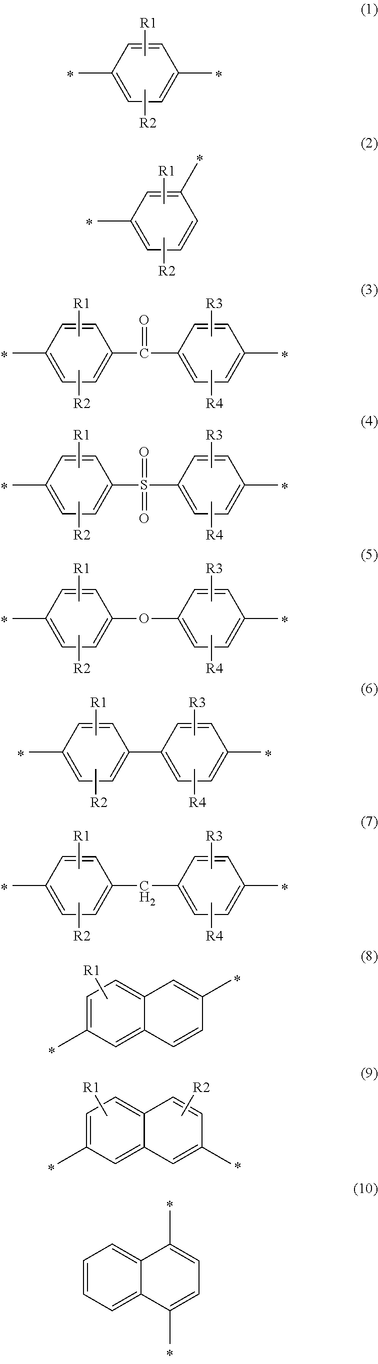 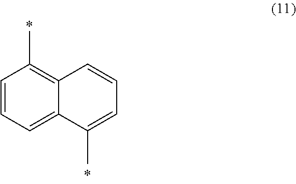
where, R1 to R4 are selected from hydrogen, alkyl group, alkoxy group, and halogen group, and * represents other coupled atom.

7. A sealed battery comprising a power generation element and a sealed battery casing, the sealed battery casing including:
a body part in which the power generation element is disposed, the body part including one or more body members; and
a sealing part sealing the body part by thermal fusion bonding, the sealing part including polyarylene sulfide-based resin having a residual sodium ion concentration of 80 ppm or less on mass basis.
